(19) United States
(12) Patent Application Publication
(10) Pub. No.: US 2024/0112541 A1
(43) Pub. Date: Apr. 4, 2024

(54) GENERATING SECOND CHANCE OPPORTUNITIES TO RANDOMLY TRIGGER A BONUS GAME

(71) Applicant: Aristocrat Technologies, Inc., Las Vegas, NV (US)

(72) Inventors: Gary Penacho, Henderson, NV (US); Daniel Mirjavadi, Las Vegas, NV (US); Allon Englman, Las Vegas, NV (US)

(21) Appl. No.: 17/957,477

(22) Filed: Sep. 30, 2022

(51) Int. Cl. G07F 17/32; G06F 7/58

(52) U.S. Cl. CPC G07F 17/3267; G06F 7/588; G07F 17/3211; G07F 17/3244

(57) ABSTRACT

An electronic gaming system includes a memory and a processor configured to execute instructions stored in the memory. The instructions, when executed, cause the processor to cause display of a base game outcome within a first play area including a number of instances of a feature symbol, and to determine that the number of instances of the feature symbol displayed in the first play area does not satisfy a first condition to trigger a feature game. The instructions, when executed, also cause the processor to determine that a second condition to trigger the feature game is satisfied by at least one random number generator outcome, wherein a probability that the second condition is satisfied corresponds to the number of instances of the feature symbol in the first play area. The instructions, when executed, also cause the processor to initiate the feature game in response to the second condition being satisfied.

### TECHNICAL FIELD

The field of disclosure relates generally to electronic gaming, and more specifically, to electronic gaming systems and methods that include generating second chance opportunities to randomly trigger a bonus game.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system includes a memory and a processor configured to execute instructions stored in the memory. The instructions, when executed, cause the processor to cause display of a base game outcome within a first play area. The first play area includes a number of instances of a feature symbol. The instructions, when executed, also cause the processor to determine that the number of instances of the feature symbol displayed in the first play area does not satisfy a first condition to trigger a feature game. The first condition is a threshold count of instances of the feature symbol displayed in the first play area during a tracking period that restarts each time the feature game is triggered. The instructions, when executed, also cause the processor to, in response to determining that the first condition is not satisfied, determine that a second condition to trigger the feature game is satisfied by at least one random number generator (RNG) outcome generated by generating a random number using an RNG and performing a lookup operation for the random number in a lookup table stored in the memory. A probability that the second condition is satisfied by the at least one RNG outcome corresponds to the number of instances of the feature symbol in the first play area. The instructions, when executed, also cause the processor to, in response to determining that the second condition is satisfied, initiate the feature game and cause display of an outcome of the feature game within a second play area. The second play area includes the number of instances of the feature symbol.

In another aspect, a non-transitory computer-readable medium contains instructions embodied thereon, which when executed by a processor, cause the processor to generate a base game outcome to be displayed within a first play area. The first play area includes a number of instances of a feature symbol. The instructions, when executed, also cause the processor to determine that the number of instances of the feature symbol displayed in the first play area does not satisfy a first condition to trigger a feature game. The first condition is a threshold count of instances of the feature symbol displayed in the first play area during a tracking period that restarts each time the feature game is triggered. The instructions, when executed, also cause the processor to, in response to determining that the first condition is not satisfied, determine that a second condition to trigger the feature game is satisfied by at least one random number generator (RNG) outcome generated by generating a random number using an RNG and performing a lookup operation for the random number in a lookup table. A probability that the second condition is satisfied by the at least one RNG outcome corresponds to the number of instances of the feature symbol in the first play area. The instructions, when executed, also cause the processor to, in response to determining that the second condition is satisfied, initiate the feature game and generate an outcome of the feature game to be displayed within a second play area. The second play area includes the number of instances of the feature symbol.

In another aspect, a computer-implemented method for providing a game on an electronic gaming system includes generating a base game outcome to be displayed within a first play area. The first play area includes a number of instances of a feature symbol. The method also includes determining that the number of instances of the feature symbol displayed in the first play area does not satisfy a first condition to trigger a feature game. The first condition is a threshold count of instances of the feature symbol displayed in the first play area during a tracking period that restarts each time the feature game is triggered. The method also includes, in response to determining that the first condition is not satisfied, determining that a second condition to trigger the feature game is satisfied by at least one random number generator (RNG) outcome generated by generating a random number using an RNG and performing a lookup operation for the random number in a lookup table. A probability that the second condition is satisfied by the at least one RNG outcome corresponds to the number of instances of the feature symbol in the first play area. The method also includes, in response to determining that the second condition is satisfied, initiating the feature game and generating an outcome of the feature game to be displayed within a second play area. The second play area includes the number of instances of the feature symbol.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates a diagram that represents an example screen shot of a base game displayed on a display screen of an electronic gaming device.

FIG. 5 illustrates a diagram that represents another example screen shot of the base game of FIG. 4.

FIG. 6 illustrates a diagram that represents an example screen shot of a feature game displayed on a display screen of an electronic gaming device, triggered during the base game of FIGS. 4 and 5.

FIG. 7 illustrates a diagram that represents another example screen shot of the feature game of FIG. 6.

FIG. 8 illustrates a diagram that represents an example screen shot of another base game displayed on a display screen of an electronic gaming device.

FIG. 9 illustrates a diagram that represents an example screen shot of a feature game displayed on a display screen of an electronic gaming device, triggered during the base game of FIG. 8.

FIGS. 10A-C illustrate a block diagram of an example computer-implemented method for generating second chance opportunities during a base game.

### DETAILED DESCRIPTION

In conventional reel-based games, in a given game outcome, a gaming device may display one or more feature symbols or objects in a viewable portion of a set of reels, i.e., within a play area, along with other base symbols or objects. Feature symbols that appear in the play area may trigger a feature game (e.g., a bonus game or a special mode). The feature game may be triggered upon a threshold count of feature symbols (e.g., six feature symbols) appearing within the play area over the course of gameplay, that is, over one or more game outcomes. In some instances, the gaming device also generates additional feature symbols that are added to the play area in a given game outcome to trigger the feature game. The probability that additional feature symbols will be added to the game outcome to trigger the feature game is the same, regardless of the number of feature symbols that appear.

Described herein is an electronic gaming system that presents technical improvements in operation, capability, and user interface (“UI”) features of electronic gaming devices, as well as improvements in features of backend processing to implement the operation, capability, and UI features. The gaming system implements a symbol-driven mechanic in an RNG-based gaming environment that generates second chance opportunities to randomly trigger a feature game (e.g., a bonus game or a special mode) based on a number of feature symbols that appear in a given outcome of a base game. As described elsewhere herein, the gaming system facilitates control over increased randomness and payout volatility associated with generating second chance opportunities based on the number of feature symbols that appear in a given game outcome. The technical improvements provided by the gaming system may be implemented, for example, in a reel game played on a gaming device, but are not limited to reel games or any particular gaming device.

The technical improvements provided herein include, inter alia, increasing the flexibility in generating second chance opportunities to trigger a feature game and varying (e.g., increasing) the probability that a second chance opportunity for the feature game is triggered. This is achieved by generating second chance opportunities based on a number of feature symbols that appear in a given game outcome. In various implementations, a game generates one or more RNG outputs (e.g., an output from a random number generator, also referred to herein as an “RNG pull” or a “second chance RNG pull”) to determine whether to trigger a second chance opportunity for the feature game. The probability of triggering a second chance opportunity for the feature game is linked to the number of feature symbols that appear in a given game outcome, and the probability of triggering a second chance opportunity for the feature game may increase when a greater number of feature symbols appear.

In one example implementation, a second chance RNG pull is generated for each feature symbol that appears in a given game outcome to determine whether to trigger a second chance opportunity for the feature game. The lookup table used for the second chance RNG pull generated for each feature symbol that appears may be the same or different. In this implementation, multiple second chance RNG pulls may be generated in a given game outcome, where multiple feature symbols appear. The probability that a second chance RNG pull will trigger the second chance opportunity for the feature game increases as more second chance RNG pulls are generated. Thereby, the probability of triggering the feature game increases as more feature symbols appear in a given game outcome. In another example implementation, a single second chance RNG pull is generated when one or more symbols appear in a given game outcome, and a separate lookup table is used for the second chance RNG pull based on the number of feature symbols that appear. The separate lookup tables associated with different numbers of feature symbols are weighted differently (or have different probabilities). As such, the probability that the second chance RNG pull triggers the feature game varies and corresponds to the probability of the lookup table used in a given second chance RNG pull. In both implementations, an additional layer of randomness in determining whether to trigger a second chance opportunity for the feature game is provided by linking the probability of triggering a second chance opportunity for the feature game to the number of feature symbols that appear in a given game outcome. This in turn facilitates increasing player excitement and experience during the course of base game play, as the player perceives additional opportunities to trigger the feature game and/or increased probability to trigger the feature game where one or more feature symbols appear in a given game outcome.

Visual feedback via one or more metamorphic graphical elements may be displayed in conjunction with the feature symbols to facilitate improving the usability of electronic gaming devices, enhancing the user experience for players, extending player time on the electronic gaming devices, and/or maintaining the interest of current players in the electronic gaming devices. Each feature symbol that appears in the play area may be used to adjust a state or level of one or more metamorphic graphical elements (e.g., a meter). The state or level of each of the one or more metamorphic graphical elements advances when each feature symbol appears in the play area, indicating that the player is nearing triggering the feature game. If the feature game is triggered, either by meeting or exceeding the threshold count of feature symbols or by triggering a second chance opportunity for the feature game, the one or more metamorphic graphical elements advance to a state or level that indicates that the feature game has been triggered. After play of the feature game, the one or more metamorphic graphical elements are reset to an initial state or level. Otherwise, the advanced state value of the metamorphic graphical element is maintained during play of successive base games.

Certain technical problems are associated with generating second chance opportunities using a symbol-driven mechanic within an RNG-based gaming environment. For example, generating second chance opportunities based on the number of feature symbols that appear during a base game increases the degree of randomness associated with a feature game being triggered, and may cause larger payouts to be awarded by increasing the feature game trigger rate. Thus, a gaming machine implementing the subject matter described herein must include proper control functions to comply with gaming regulations, such as achieving a designated game return to player (“RTP”), and managing volatility of payouts. These technical problems are unique to gaming technology that generates second chance opportunities using a symbol-driven mechanic in an RNG-base gaming environment, and are not presented in conventional gaming devices that use the same probability to determine whether to add additional feature symbols to trigger the feature game, regardless of the number of feature symbols that appear in a given game outcome. As conventional gaming devices have not faced the technical problems presented by the gaming technology described herein, no technical solution to these technical problems exists.

In view thereof, in order to solve the technical problems presented by generating multiple second chance opportunities based on a number of feature symbols that appear during a base game, the gaming system described herein provides various tools for managing volatility and RTP in a computationally-effective way, while also enabling improved usability and enhanced user experience. For example, the gaming system described herein facilitates controlling and/or managing the degree of randomness that is otherwise increased by generating second chance opportunities that could trigger a feature game using a symbol-driven mechanic. In one example implementation, where each feature symbol that appears in the play area during a given game outcome independently generates a second chance RNG pull to determine whether to trigger the feature game, the lookup table used for each second chance RNG pull is appropriately weighted to regulate the probability that any one second chance RNG pull triggers the feature game. In this example implementation, to facilitate further control, the gaming system adds feature symbols to achieve a threshold count of feature symbols once entering the feature game. Alternatively stated, in this implementation, the gaming system delays the display of feature symbols in the play area until after the feature game has begun. Delaying the display of the feature symbols that result from the feature game being randomly triggered by a second chance opportunity facilitates better control of prizes awarded on the feature symbols. For example, instead of using base game weight tables and credit values for the additional feature symbols, the gaming system may use feature game weight tables and credit values for the additional feature symbols to award the prize to better control and balance the RTP.

In the second example implementation, where the probability that a second chance RNG pull triggers a feature game varies based on separate lookup tables that are weighted according to the number of feature symbols that appear in the play area during a given game outcome, the separate lookup tables are each appropriately weighted to control an overall rate of triggering the feature game. In this second implementation, the gaming system maps the second chance opportunities associated with a different number of feature symbols to differently weighted tables to better control the degree of randomness. Mapping the different number of feature symbols to differently weighted tables facilitates better control regarding the average number of feature symbols with which the feature game begins and ends.

In view thereof, the gaming system described herein facilitates improving gaming device operation, capability, and user interface features at least by generating second chance opportunities to trigger a feature game based on a number of feature symbols that appear in a given game outcome. Such improvements introduce technical problems, including at least increasing randomness generated during gameplay and increasing payout volatility. In order to provide a technical solution to these technical problems, the gaming system described herein provide tools that facilitate managing and/or controlling the degree of randomness and payout volatility during gameplay, for example, by controlling a payout structure attributed to feature symbols that appear as a result of a second chance opportunity being triggered.

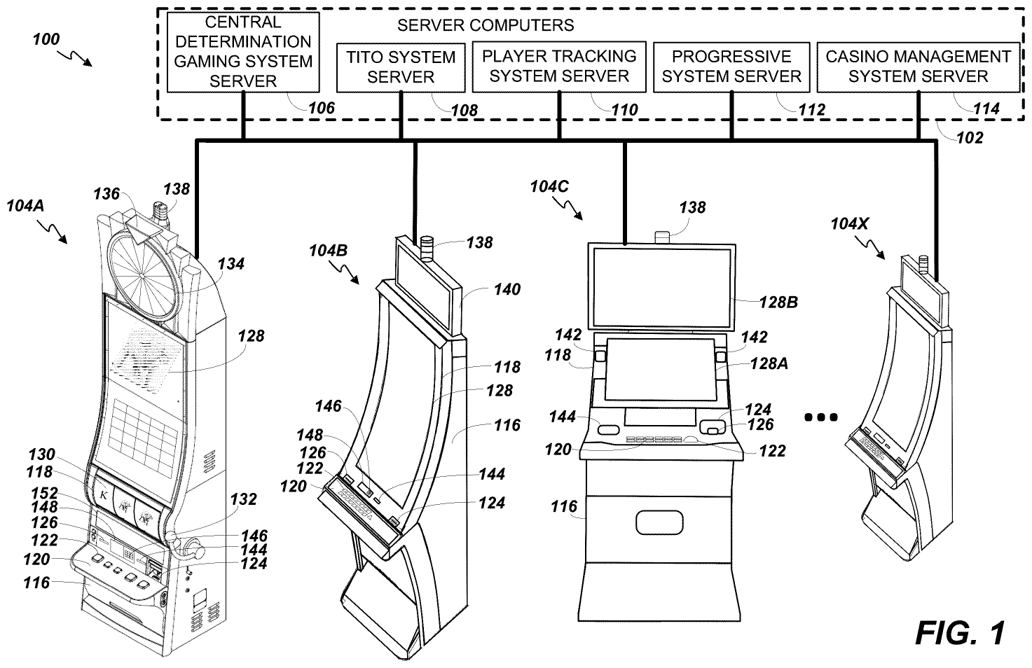

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

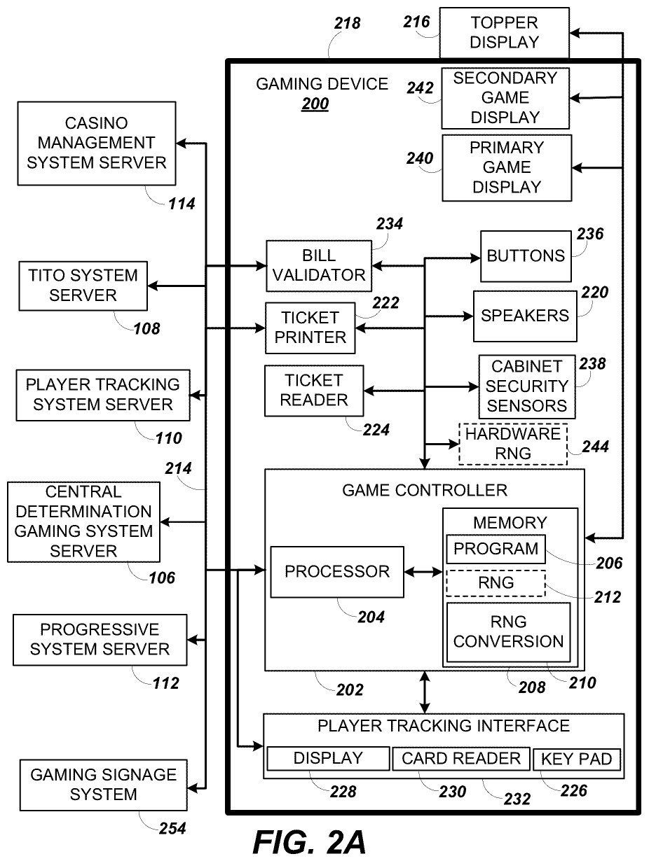

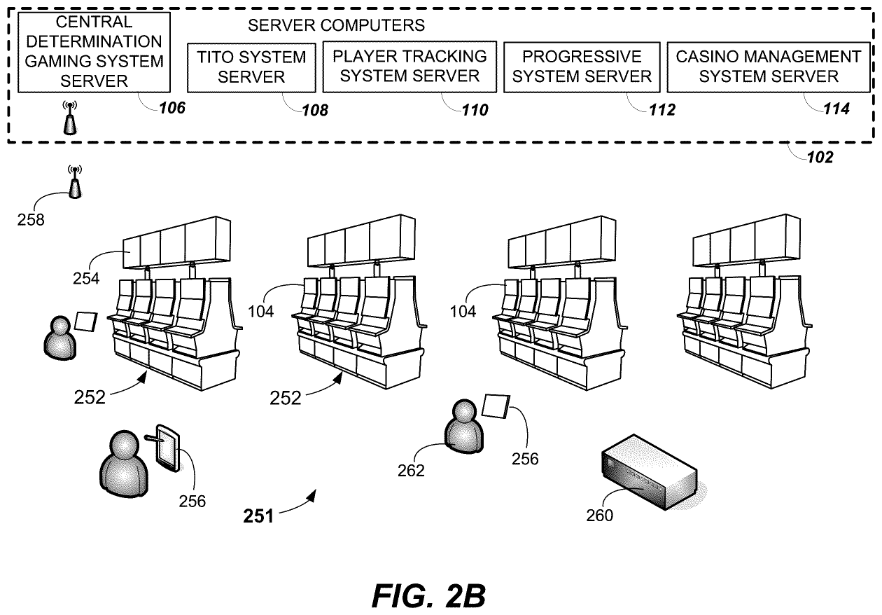

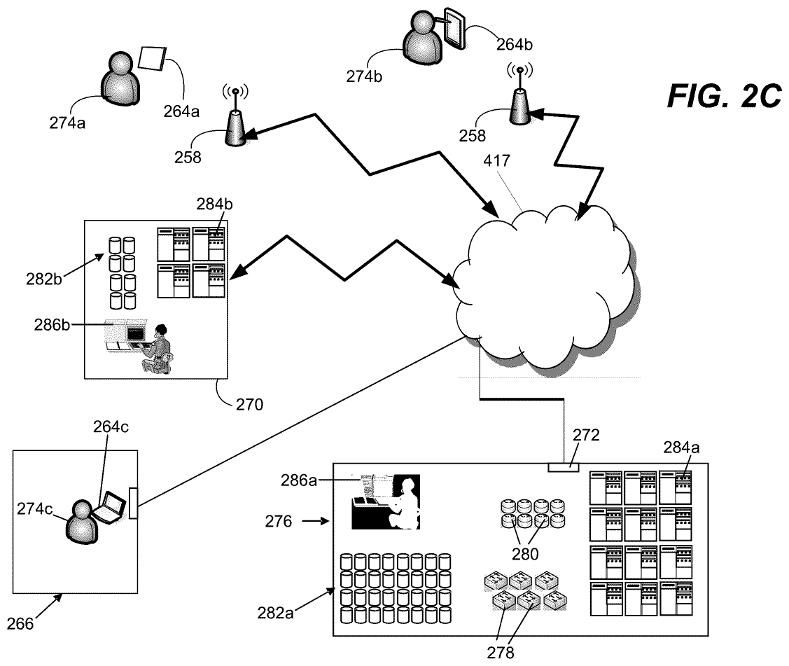

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

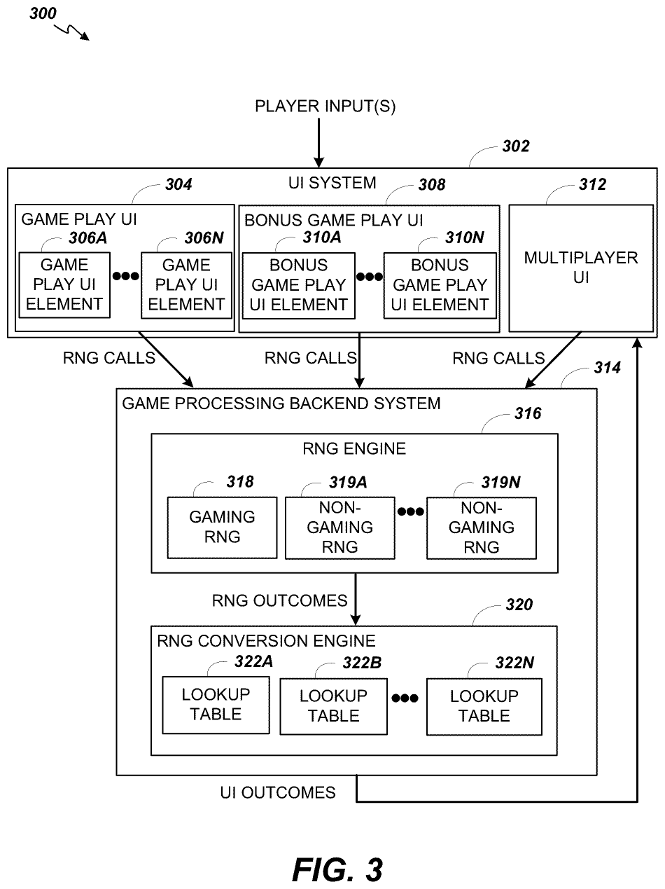

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

Example Reel Games, Feature games, and Outcome Determinations.

Electronic gaming systems described herein may provide various types of reel games or other games. A reel game can be a base game or bonus reel game. A base, or primary, reel game includes play that involves spinning reels. A bonus, or secondary, reel game/feature can add the possibility of winning a relatively large payout. A bonus reel game/feature may require an additional wager, but typically does not. A single play of a reel game can constitute a single complete game or wager, e.g., a single spin of the reels or a series of spins which culminate in a final aggregate outcome. In some example implementations, an electronic gaming device can conduct a base game, a bonus reel game, and a gateway wheel game. A reel game uses spinning reels and one or more play areas (game windows) on a display screen.

For a reel game, a play area encloses viewable portions of a set of reels associated with the play area. For each of the reels, the viewable portion of the reel includes one or more positions for symbols. Thus, the play area is a matrix of symbols on a display screen, and may be highlighted graphically to emphasize reels and symbols within the play area. The number of reels and dimensions of the play area depend on implementation. In some typical configurations, a play area has an m×n configuration, with m reels and with n symbols visible per reel. For example, for a base game, a play area can have a 5×3 configuration—five reels per window, with three symbols showing in the window for each of the reels, or a 5×4 configuration— five reels per window, with four symbols showing in the window for each of the reels. More generally, the play area spans m reels in a first dimension and spans n symbols in a second dimension orthogonal to the first dimension, where the value of m can be 4, 5, 6, 7, 8, or some other number of reels, and the value of n can be 2, 3, 4, 5, 6, or some other number of symbols. Typically, the m reels are arranged horizontally in the play area from left-to-right, with the m reels spinning vertically and the play area showing n symbols of each of the respective reels. Alternatively, the m reels are arranged vertically in the play area from top-to-bottom, with the m reels spinning horizontally and the play area showing n symbols of each of the respective reels. Alternatively, a play area can have another configuration. For example, a play area can have different numbers of symbols visible for different reels (e.g., going left to right in a play area, two symbols visible for a leftmost reel, three symbols visible for a second reel, four symbols visible for a center reel, three symbols visible for a fourth reel, and two symbols visible for a rightmost reel). Or, as further explained below, a play area can have a p×q configuration, with p×q reels visible in a rectangular play area, and a single symbol visible per reel.

For each of the reels, a reel strip includes x positions along a one-dimensional strip of symbols, where x depends on implementation. For example, x is 30, 80, 100, 200, or some other number of positions. The value of x can be the same or different for different reels (thus, different reels can have different numbers of positions). Each reel can have a data structure (e.g., array, linked list) that tracks the symbols at the respective positions of the reel strip for the reel. In some example implementations, the configuration of the symbols at the positions of the reel strips for the reels of a reel game is fixed after the reel game boots, although limited reconfiguration operations may be permitted. In other example implementations, the configuration of the symbols at the positions of the reel strips for the reels of a reel game can change dynamically after the reel game boots (e.g., depending on bet level or some other factor). Different sets of reels can be used for a base game and bonus reel game (or other feature game such as a special mode of the base game). For example, for a special mode of a base game, more “valuable” symbols, such as wild symbols or scatter symbols, can be added to the reels of a base game or swapped in for other symbols on the reels.

The symbol set for reels has various types of symbols, including target symbols, feature symbols (which trigger a bonus game), and other symbols. The symbols can be static or animated. In some example implementations, the symbol set for the reels includes a target symbol type, at least one jackpot symbol type, a wild symbol type, some number of picture symbol types, some number of minor/low symbol types, and a feature symbol type (which triggers bonuses). Alternatively, the symbol set for the reels can include other and/or additional symbols. The symbol set can be the same or different between a base game and bonus reel game (or other feature game). In some example implementations, some types of symbols are dimmed out (not active) at times (e.g., symbols other than feature symbols are dimmed out during a feature game or bonus game).

As in a reel game with physical reels, the reels of a reel game on a display screen “spin” graphically through a play area on the display screen when a player actuates a “spin” or “play” button, which acts as a “handle pull” event. A backend system randomly selects symbol stop positions in the respective reels, and the respective reels stop at the selected symbol stop positions, with some number of symbols visible in the game window for each of the reels. For example, for a given reel, the backend system generates a random number and determines a symbol stop position on the reel strip of the reel using the random number (e.g., with a lookup table). The backend system generates different random numbers for the respective reels that are spun. In this way, the backend system can determine which symbols of the respective reels are visible in the game window (play area) on the display screen. In other scenarios, symbols visible in a play area can be “transferred” from another play area when certain conditions are satisfied. For example, symbols can be graphically transferred or otherwise added to the play area for a bonus reel game from a base game upon the occurrence of certain conditions for the base game.

A display screen (or simply “display” or “screen”) for a reel game is an area that conveys information to a viewer. The information may be dynamic, in which case, the display screen may use LCD technology, LED technology, CRT technology, or some other display technology. A main display screen (also called a primary game screen or main display) can be a display screen or an area of a display screen used to display game information related to a base game, such as a video representation of one or more spinning reels. A secondary display screen (also called a secondary game screen or bonus display) can be a display screen or an area of a display screen used to display secondary game information, such as animations and other graphics (e.g., metamorphic graphical elements or simply “metamorphics”) associated with a bonus reel game. A credit display can display a player's current number of credits, cash, account balance, or the equivalent. A bet display can display a player's amount wagered. The credit display and/or bet display may be standalone displays, independent of the main display and bonus display. Alternatively, the credit display and/or bet display can be incorporated into the main display or bonus display. Any of the display screens can be implemented as a touchscreen, with an associated touchscreen controller. In this case, such display screens may be operated as input devices in addition to presenting information, to provide input game play decisions (e.g., actions on and selection of game presentation objects).

An electronic gaming device may award a feature game, such as a bonus reel game, a special mode for a base game, or other feature game to a player. A feature game may enhance the electronic gaming device and the experience of players by adding elements of excitement and chance. The feature game can utilize a different set of reels, display screens, controls, symbols, etc. than the base game in normal operation. Alternatively, the feature game can reuse or reconfigure at least some of the reels, display screens, symbols, etc. of a base game. The feature game can be started in response to satisfaction of a trigger condition. For example, as described elsewhere herein, the feature game can be triggered upon the occurrence of some defined combination of symbols or threshold count of feature symbols in one or more sets of reels. Alternatively, the feature game can be triggered in some other way.

In some example implementations, the feature game is a hold-and-spin feature, which is a type of bonus reel game. The hold-and-spin feature is activated for a play area that encloses at least a threshold count of feature symbols (i.e., the symbols that trigger the bonus reel game). During the hold-and-spin feature, reels can include symbols from the same set of symbols as a base game or a different set of symbols. To distinguish from regular gameplay, inactive symbols (symbols other than feature symbols) can be displayed differently during the hold-and-spin feature (e.g., with lower brightness). The feature symbols remain active during the hold-and-spin feature. During the hold-and-spin feature, feature symbols are held in place (locked) in a play area while reels spin for other symbol positions of the play area. For example, each symbol position in a play area can have its own reel. Thus, for each of the 15 symbol positions of a play area with a 5×3 configuration of reels, the hold-and-spin feature can use a different reel. (But no reel spins in a position when a feature symbol is held in that position.) Initially, a player is given r spins for the hold-and-spin feature in a play area. For example, r is 3. Alternatively, r has some other value. When the player actuates a button to spin the reels or otherwise starts a spin of the hold-and-spin feature, all non-locked reels in the play area spin and eventually stop, and r is decremented. If any new feature symbols appear in the play area, those new feature symbol(s) as well as previous feature symbols are held in place (locked) and r is reset to its initial value. Locked feature symbols are held until the end of the hold-and-spin feature. When r reaches 0 or all symbol positions are occupied by feature symbols, an outcome is determined based on the feature symbols (e.g., adding credit values of the feature symbols).

Alternatively, another type of feature game can be activated if a play area includes at least a threshold count of feature symbols.

In general, a backend system can determine various outcomes and perform operations for various types of feature games. A UI system can then output indications of those outcomes and perform operations for various types of feature games. For example, for various types of events, the backend system uses a RNG to generate a random number and maps the random number to an outcome using a lookup table. FIG. 3 shows examples of lookup tables 322A . . . 322N, which are also called weighted tables. In general, a lookup table can be implemented as any data structure that assigns probabilities to different options, in order for one of the different options to be selected using a random number. Different options are represented in different entries of a lookup table. The probabilities for different options can be reflected in threshold values (e.g., 0<RND<=40 for option 1, 40<RND<=70 for option 2, 70<RND<=90 for option 3, and 90<RND<=100 for option 4, given four options and a random number RND where 0<RND<=100). The threshold values can represent percentages or, more generally, sub-ranges within the range for a random number. In some example implementations, the threshold values for a lookup table are represented as count values (weights) for the respective entries of the lookup table. For example, the following table shows count values for the four options described above:

TABLE 1
Example Lookup Table

| Count Value | Entry |
|---|---|
| 40 | <value a1, value a2, . . . > |
| 30 | <value b1, value b2, . . . > |
| 20 | <value c1, value c2, . . . > |
| 10 | <value d1, value d2, . . . > |

The sum total of the count values (weights) indicates the range of the options. The backend system can use a random number, generated between 1 and the sum total of the count values, to select one of the entries in the lookup table by comparing the random number to successive running totals. In the example shown in Table 1, if the random number is 40 or less, the first entry is selected. Otherwise, if the random number is between 41 and 70, the second entry is selected. Otherwise, if the random number is between 71 and 90, the third entry is selected. Otherwise, the last entry is selected. The threshold values for a lookup table can be fixed and predetermined. Or, the threshold values for a lookup table can vary dynamically (e.g., depending on bet level). Or, a lookup table can be dynamically selected (e.g., depending on bet level, depending on another factor) from among multiple available lookup tables. Different parameters or choices during game play can use different lookup tables. Or, different combinations of parameters or choices can be combined in entries of a given lookup table.

After reels have landed (stopped) in a play area, any win conditions can be detected and any win amounts can be awarded to the player (e.g., credited to the player's credit balance). In some examples, win conditions depend on a count of feature symbols in a play area. In other examples, win conditions are defined as pay lines (also called win lines) across at least a portion of a play area on a display screen. For a round of play, when a certain combination of symbols appears along a pay line, a win amount corresponding to that combination of symbols and that pay line is awarded. Win amounts can vary according to the combination of symbols and according to the particular pay line along which the combination of symbols appears. Win amounts are typically determined according to a pay table, where the pay table comprehends the various combinations of symbols and pay lines that may occur (i.e., the win conditions). The win amount for a round of play may be a fraction of an amount wagered for that round of play for certain win conditions. For other win conditions, the win amount may be much larger than the amount wagered. The number of pay lines and base credit cost to play depends on implementation. In some example implementations, there are 50 pay lines and a 150 credit cost. There are 2×, 3×, 4×, and 5× bet multipliers (also called bet levels), which sets a max bet of 650 credits. Multipliers can also appear as symbols in reels. Alternatively, there could be higher bet multipliers (e.g., up to 8×, with a max bet of 1200 credits), different credit options, and/or a different number of pay lines.

Instead of evaluating win conditions on pay lines across reels in a play area, an award can be determined according to a “ways” approach. For example, a player may obtain a win entitlement by selecting a number of reels to play and an amount to wager per reel. The selection of a reel means that each displayed symbol of the reel (in the play area) can be substituted for a symbol at one or more designated display positions. In other words, all symbols displayed at symbol display positions in the play area for a selected reel can be used to form symbol combinations (one symbol per reel in a combination) with any of the symbols displayed at designated, symbol display positions of each of the other reels. For example, if there are five reels and three symbol display positions for each reel in a play area (such that the symbol display positions comprise three rows of five symbol display positions), the symbol displayed in the center row is used for a non-selected reel, and the symbols displayed in all three rows are used for a selected reel. Each possible path through the designated (active) symbol display position(s) of the respective reels provides a way to win. As a result, the total number of ways to win is determined by multiplying the number of active display position(s) of each reel, where the active display position(s) for a reel are all display positions in the play area for a selected reel but only the designated (e.g., center) display position in the play area of a non-selected reel. As a result, for five reels and fifteen display positions, there are 35=243 ways to win if five reels are selected, 3×3×3×1×1=27 ways to win if three reels are selected, and so on.

### Generating Second Chance Opportunities to Trigger a Feature Game.

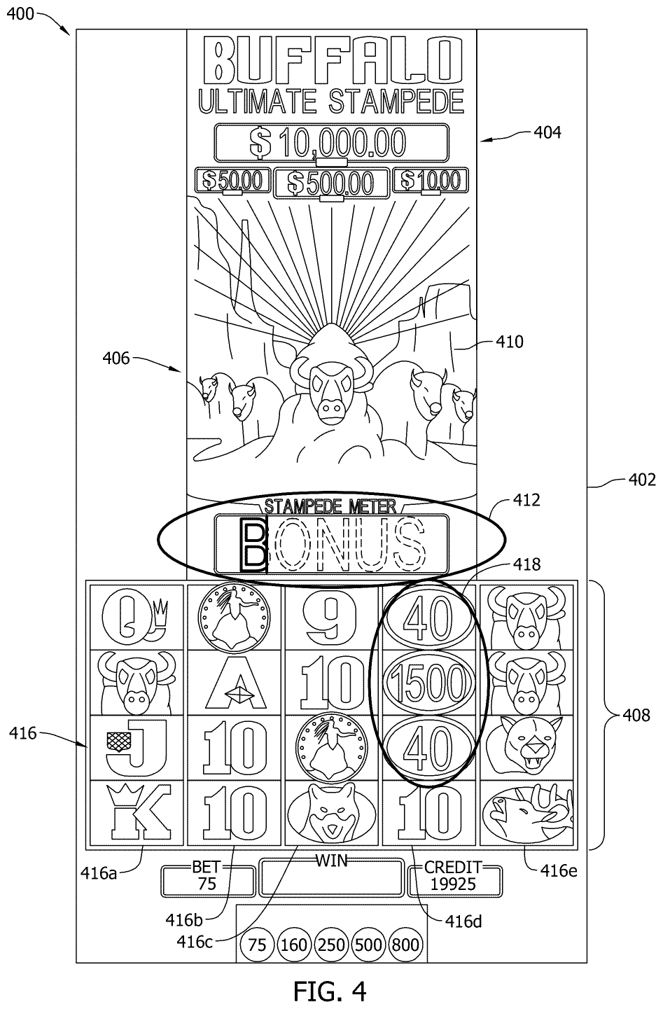

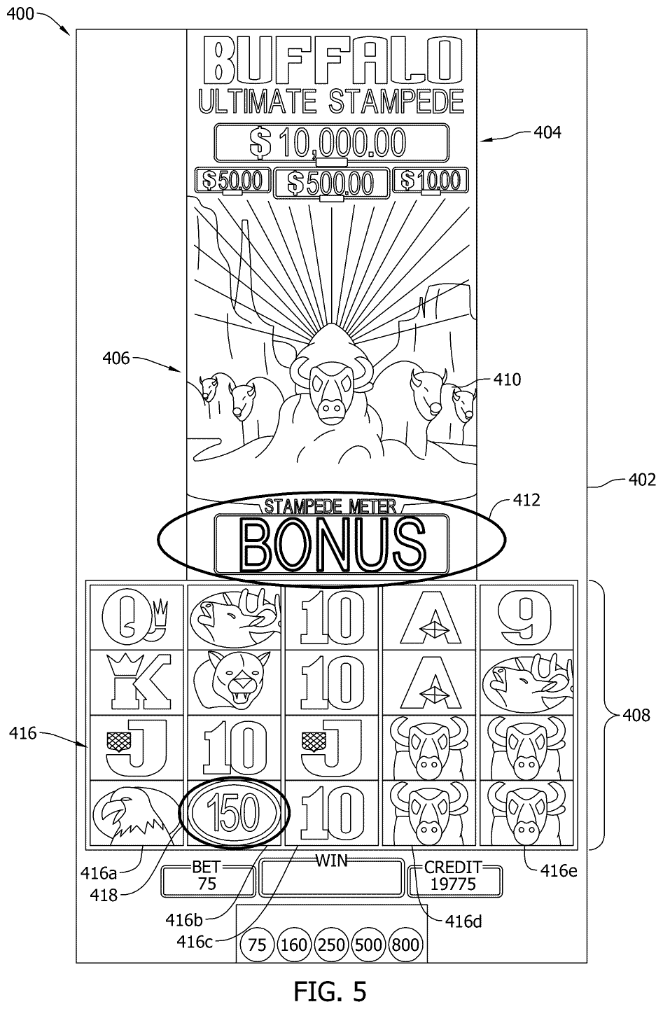

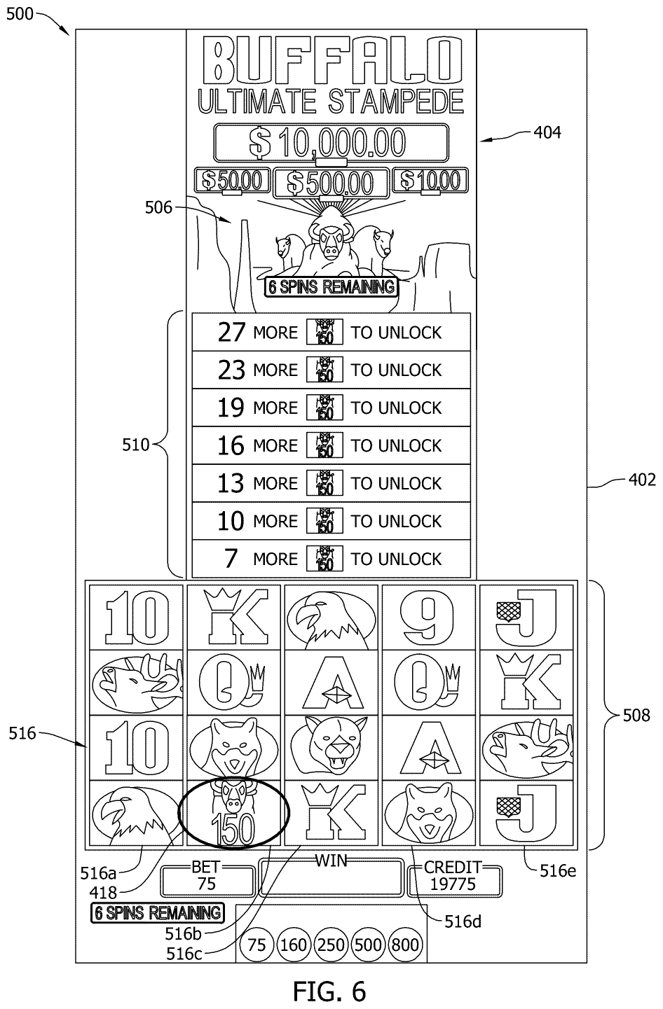

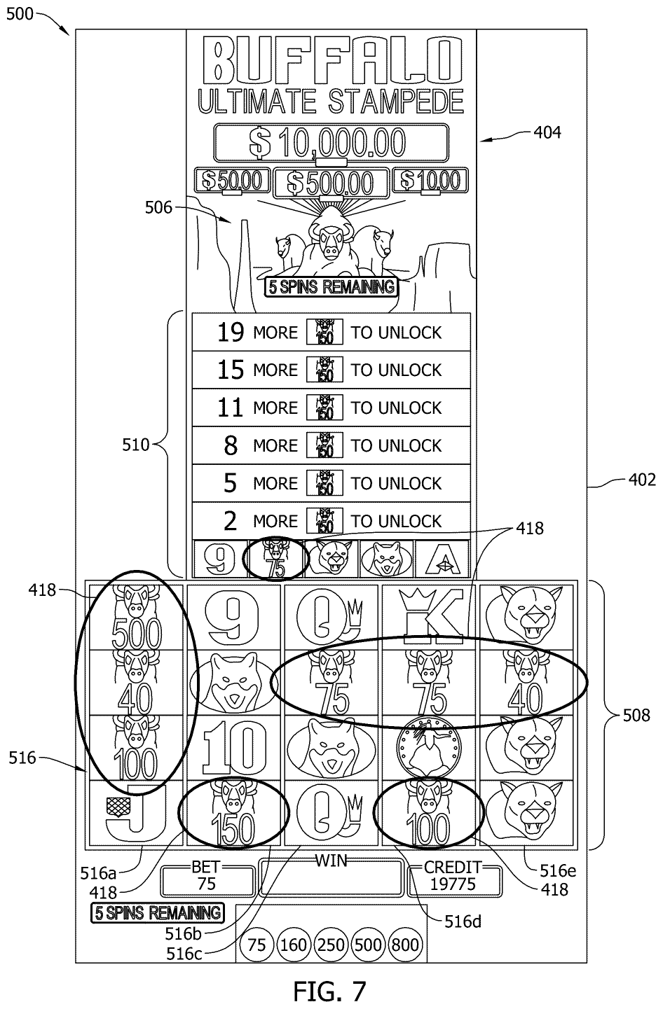

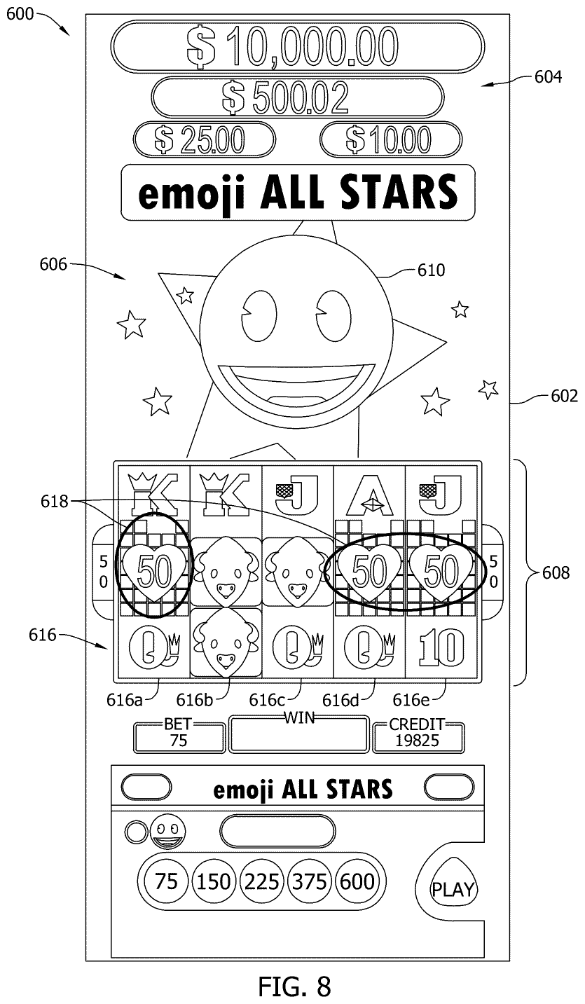

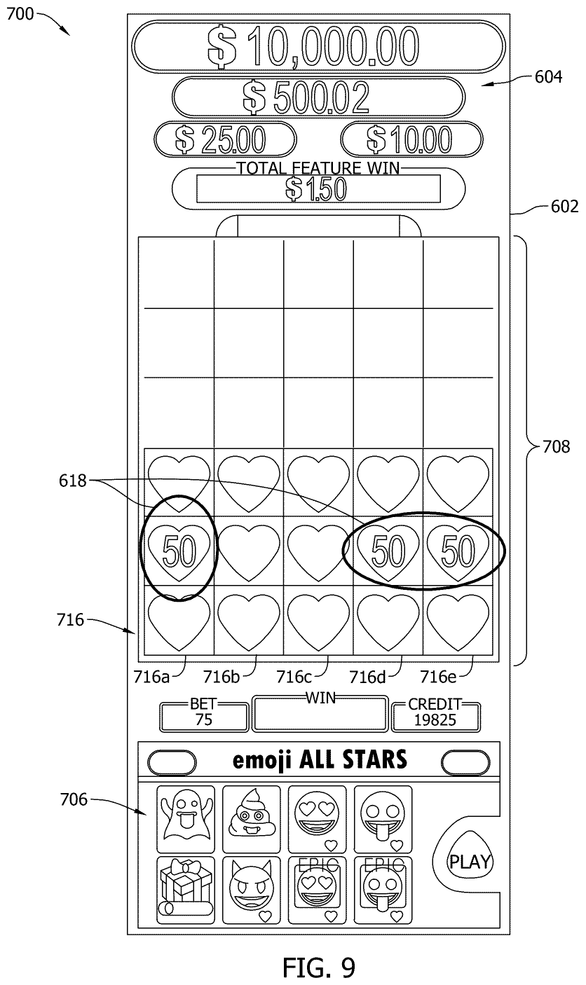

With reference to FIGS. 4-9, alternative implementations of use of a symbol-driven mechanic in an RNG-based gaming environment to generate second chance opportunities to trigger a feature game will now be described. FIGS. 4-7 are diagrams that represent example screen shots of a display screen 402 of an electronic gaming device (e.g., gaming device 104A-X in FIG. 1 or gaming device 200 in FIG. 2) on which a base game 400 (FIGS. 4 and 5) is displayed and, subsequently, a feature game 500 (FIGS. 6 and 7) triggered by a second chance opportunity during the base game 400. FIGS. 8 and 9 are diagrams that represent example screen shots of a display screen 602 of an electronic gaming device (e.g., gaming device 104A-X in FIG. 1 or gaming device 200 in FIG. 2) on which a base game 600 (FIG. 8) is displayed and, subsequently, a feature game 700 (FIG. 9) triggered by a second chance opportunity during the base game 600. The screen shots may be rendered on a main display screen, secondary display screen, or other display screen of an electronic gaming device. The screen shots may additionally or alternatively be rendered on a display screen of a mobile device (e.g., mobile gaming devices 256 in FIG. 2).

In the example implementations, the base game 400 and the base 600 are each reel-based games and the feature game 500 and the feature game 700 are each bonus hold-and-spin games that involve one or more free spins. In various embodiments, gaming systems may implement the improvements described herein in other wagering games and are not limited to reel games. Further, although the example implementation involve a bonus reel game, in other embodiments, another feature game may be triggered. For example, the feature game may be a special mode that adds wild symbols, scatter symbols, or other symbols to reels of a base game, or another special mode.

During play of a base game (e.g., base game 400 in and/or base game 600) displayed an electronic gaming device, a feature game (e.g., feature game 500 and/or feature game 700) can be triggered upon satisfying a first condition which represents a “first chance” to trigger the feature game. In the example implementations, the first condition to trigger the feature game is a threshold count of instances of a feature symbol in a set of reels that are displayed, or appear, in a play area or matrix over the course of game play (i.e., one or more plays of a base game). The threshold count may be six instances of a feature symbol, for example, or any other number of instances of a feature symbol. The first condition may be satisfied by a number of instances of a feature symbol appearing over a tracking period that includes one or more successive plays of the base game, where the number of instances of the feature symbol meets or exceeds the threshold count. In this regard, the first condition may be satisfied by the threshold count of instances of the feature symbol appearing over multiple plays of the base game.

The tracking period restarts each time the feature game is triggered, whether by satisfying the first condition (e.g., displaying the threshold count of instances of the feature symbol over the tracking period) or by satisfying a second condition, described in further detail below. The tracking period may additionally restart each time a player cashes out and/or otherwise terminates a gameplay period on the gaming device. The tracking period alternatively may continue once a player has cashed out so that, once a subsequent player initiates play of the base game, the number of instances of the feature symbol that appeared during play of the base game by the previous player count toward satisfying the first condition for the subsequent player. As described in further detail below, one or more metamorphic graphical elements or metamorphics may be displayed on the gaming device, and a state or level of the metamorphic indicates the status of the first condition (i.e., how many instances of the feature symbol have appeared over the current tracking period and/or how close the first condition is to being satisfied during the current tracking period).

A “second chance” opportunity is generated when one or more feature symbols appear in the reel matrix (or play area) during the base game, and the display of the one or more instances of the feature symbol does not satisfy the first condition (i.e., does not reach the threshold count of instances of the feature symbol over the tracking period to trigger the feature game). The second chance opportunity is an additional opportunity to trigger the feature game by determining that a second condition is satisfied. Whether the second condition is satisfied is determined by an RNG outcome (also referred to herein as an “RNG pull” or “a second chance RNG pull”). To generate a second chance RNG pull, a random number is generated, and a lookup operation is performed for the random number in a lookup table (e.g., one or more of lookup tables 322A . . . 322N in FIG. 3), to map the random number to an outcome that corresponds to a “yes” or “no” decision for whether to trigger the feature game. The second chance RNG pull may be generated by the RNG engine 316 which uses the gaming RNG 318 to generate one or more random numbers, which are passed to the RNG conversion engine 320, and the RNG conversion engine 320, using one or more of the random number(s) and one or more of the lookup tables 322A . . . 322N, determines whether the second condition is satisfied based on the “yes” or “no” outcome for triggering the feature game.

In the example implementations of generating second chance opportunities to trigger a feature game shown in FIGS. 4-9, the probability that the second chance opportunity is triggered (i.e., the second condition is satisfied) by the generated second chance RNG pull corresponds to the number of instances of the feature symbol displayed in the play area in a given game outcome. In various implementations, the probability of triggering the second chance opportunity increases when a greater number of instances of the feature symbol are displayed in a given game outcome.

With reference to FIGS. 4 and 5, the base game 400 in the first implementation is a reel-based game displayed on the display screen 402. FIG. 4 shows a first outcome of the base game 400 and FIG. 5 shows a second outcome of the base game 400 played after the first outcome in FIG. 4. Each of the first outcome shown in FIG. 4 and the second outcome shown in FIG. 5 are displayed over a single tracking period of the base game 400. The sequence of the base game 400 shown in FIGS. 4 and 5 is for example only and is not a limiting representation of the base game 400.

The display screen 402 includes a jackpot area 404, a metamorphic area 406, and a play area 408. The metamorphic area 406 includes a first metamorphic 410 and a second metamorphic 412. The metamorphics 410 and 412 are transformed during play of the base game 400 between multiple states or levels, which are associated with the first and/or second trigger conditions for the feature game 500. Transformation of the metamorphics 410 and 412 and their association with the first and second trigger conditions for the feature game 500 will be described in further detail below.

The play area 408 encloses viewable portions of a set of reels 416 (also referred to herein as a plurality of reels 416). In FIGS. 4 and 5, the play area 408 encloses viewable portions of five reels 416a-416e. For each of the plurality of reels 416, the viewable portion of each reel includes four positions for a symbol of the reel. The symbol set for each of the plurality of reels 416 has various types of symbols, including a feature symbol 418 and other symbols (not labeled). The feature symbol 418 is a cash-on-reel symbols in this example. Each instance of a cash-on-reel symbol is assigned a payout value that is awarded (as a monetary or credit value) in response to displaying the cash-on-reel symbol. The payout value assigned to each instance of a cash-on-reel symbol that appears in the play area 408 may be awarded after the base game 400 or after the feature game 500, if triggered. Each instance of the cash-on-reel symbol displays the monetary or credit payout value assigned to the instance of the cash-on-reel symbol. Alternatively, the play area 408 can have some other configuration of reels (different dimensions) and/or have different type of feature symbol 418. The play area 408 may also be referred to herein as a “reel matrix” or a “matrix of symbols.”

In the example base game 400, each instance of the feature symbol 418 appearing in the play area 408 during the respective outcome of the base game 400 may trigger the feature game 500 (FIGS. 6 and 7) by satisfying either the first condition or the second condition (also referred to herein as the first trigger condition and the second trigger condition, respectively). As described above, the first trigger condition is satisfied upon displaying a number of instances of the feature symbol 418 in the play area 408 during the base game 400 that meets or exceeds a threshold count. In the example base game 400, the threshold count is six instances of the feature symbol 418. The threshold count may be any number of instances of the feature symbol 418 in other examples, and may be selected based on RTP and other considerations. Moreover, the threshold count to satisfy the first trigger condition may be met or exceeded by instances of the feature symbol 418 appearing over the course of multiple outcomes of the base game 400 displayed during a single tracking period. For example, although not specifically shown in the base game 400 sequence in FIGS. 4 and 5, displaying a total of six or more instances of the feature symbol 418 in the play area 408 between the first outcome and the second outcome of the base game 400 satisfies the first trigger condition and trigger the feature game 500. Any number of instances of the feature symbol 418 appearing in the play area during outcomes of the base game 400 displayed prior to the outcomes in FIGS. 4 and 5, and during the same tracking period, would also count toward satisfying the first trigger condition. As description of the example implementation shown in FIGS. 4-7 proceeds, it will be assumed that the threshold count of instances of the feature symbol 418 to satisfy the first trigger condition has not been met or exceeded during the tracking period.

In the first outcome of the base game 400 shown in FIG. 4, three instances of the feature symbol 418 appear in the play area 408. As the first trigger condition is not satisfied by the three instances of the feature symbol 418 appearing in the play area 408, a second chance RNG pull is generated to determine whether the second trigger condition is satisfied. That is, the RNG pull for the second trigger condition is generated in response to instances of the feature symbol 418 appearing in the play area 408 and in response to the first trigger condition not being satisfied. In the example base game 400, a second chance RNG pull is generated for each instance of the feature symbol 418 that appears in the play area 408. Thus, for the outcome shown in FIG. 4, three second chance RNG pulls are generated.

For each second chance RNG pull, a random number is generated and a lookup operation for the random number in a lookup table is performed to map the random number to an outcome or a decision that determines whether the second condition is satisfied to trigger the feature game 500. The same lookup table may be used for each second chance RNG pull in this example implementation. However, separate lookup tables may be utilized. The lookup table is suitably weighted to control randomness and volatility by controlling the distribution of second chance RNG pulls that satisfy the second trigger condition (i.e., controlling the overall “hit rate” of the second trigger condition). Where separate lookup tables are utilized for each second chance RNG pull, different weights may be associated with different payout values assigned to the cash-on-reel symbols. As described in further detail below, during the feature game 500, the instances of the feature symbol 418 are graphically “transferred” from the play area 408 to a second play area 508 of the feature game 500. The payout value assigned to the transferred instance of the cash-on-reel symbol may increase during the feature game 500. The lookup tables associated with instances of the cash-on-reel symbol having higher payout values may be weighted to reduce the hit rate of the second trigger condition when these instances appear. In this way, payout volatility and RTP may be controlled.

As indicated by the sequence of the base game 400 between FIGS. 4 and 5, each of the three second chance RNG pulls generated for each of the three instances of the feature symbol 418 that appeared in the outcome of FIG. 4 did not satisfy the second trigger condition in this example. Thus, a subsequent play of the base game 400 may be initiated. The tracking period continues, and the three instances of the feature symbol 418 that appear in the outcome of FIG. 4 count toward satisfying the first trigger condition. In the subsequent outcome of the base game 400 shown in FIG. 5, one instance of the feature symbol 418 is displayed or appears in the play area 408. As above, the instance of the feature symbol 418 that appears in the outcome of FIG. 5 does not satisfy the first trigger condition (i.e., does not result in the threshold count of the feature symbols 418 during the tracking period being met or exceeded). As a result, a second chance RNG pull is generated in response to the instance of the feature symbol 418 appearing in the play area 408 and in response to the first trigger condition not being satisfied. Because one instance of the feature symbol 418 appears in the outcome shown in FIG. 5, one second chance RNG pull is generated.

With reference now to FIGS. 6 and 7, a feature game 500 is triggered in response to the second chance RNG pull generated by the instance of the feature symbol 418 appearing in the outcome of FIG. 5. That is, the feature game 500 is triggered in response to the second trigger condition being satisfied. The feature game 500 shown and described may also be triggered by satisfying the first condition. That is, the first trigger condition and the second trigger condition may trigger the same feature game 500. However, in other embodiments, the first trigger condition and the second trigger condition may trigger different feature games.

The feature game 500 in this example implementation is a hold-and-spin bonus game displayed on the display screen 402. The display screen 402 includes the jackpot area 404, a supplemental metamorphic area 506, a second play area 508, and a supplemental play area 510. The supplemental metamorphic area 506 displays the number of free spins remaining for the feature game 500 and may display additional animations during the feature game 500. In this example implementation, six free spins are awarded during the feature game 500, however, any number of free spins may be awarded, such as three, four, five, or six free spins.

The outcome of each spin of the feature game 500 is displayed in the second play area 508 that replaces the play area 408 (which may also be referred to as the first play area 408) on the display screen 402. The second play area 508 encloses viewable portions of a second set of reels 516 (also referred to herein as a second plurality of reels 516). The second play area 508 has the same dimensions as the first play area 408 in this example implementation. Thus, in FIGS. 6 and 7, the play area 508 encloses viewable portions of five reels 516a-516e, and for each of the plurality of reels 516, the viewable portion of each reel includes four positions for a symbol of the reel. The second set of reels 516 may be the same set of reels (i.e., includes the same reel strips) as the first set of reels 416, or may be a different set of reels. The symbol set for each of the plurality of reels 516 includes the feature symbol 418. As above, the feature symbol 418 is a cash-on-reel symbol in this example. Alternatively, the second play area 508 can have some other configuration of reels (different dimensions) and/or have different type of feature symbol. During the feature game 500, the instances of the feature symbol 418 and their respective symbol positions in the second play area 508 are emphasized, for example, by not showing other symbols or showing other symbols in their respective symbol positions in the second play area 508 in a darkened state. The second play area 508 may also be referred to herein as a “second reel matrix” or a “second matrix of symbols” and the first play area 408 referred to as the “first reel matrix” or the “first matrix of symbols.”

As shown in the sequence between FIGS. 5 and 6, the instance of the feature symbol 418 that appeared in the outcome of the base game 400 in FIG. 5 is included, or graphically transferred from the first play area 408, in the second play area 508 of the feature game 500. As the spins of the feature game 500 begin, the instance(s) of the feature symbol 418 from the immediately preceding outcome of the base game 400 is held in position in the second play area 508. In this example, the one instance of the feature symbol 418 that appeared during the outcome of the base game 400 is included in the second play area 508. If, for example, one of the second chance RNG pulls generated by one of the three instances of the feature symbol 418 that appeared during the outcome of the base game 400 in FIG. 4, each of the three instances of the feature symbol 418 would be included in the second play area 508 as the spins of the feature game 500 begin. The instance(s) of the feature symbol 418 is shown located at the same symbol position in the second play area 508 as in the first play area 408, but may be included or transferred into a different symbol position.

As the spins of the feature game 500 continue, the instances of the feature symbol 418 from the base game 400 and additional instance(s) of the feature symbol 418 that appear during spins of the feature game 500 are held in their respective positions (illustrated in FIG. 7). The supplemental play area 510 encloses additional viewable portions of the second set of reels 516 (or viewable portions of a different set of reels) that are “unlocked” during the feature game 500 based on a number of instances of the feature symbol 418 that appear in the second play area 508 (the total number of instances of the feature symbol 418 from the base game 400 and any additional instances of the feature symbol 418 that appear in the second play area 508 during the feature game 500). In the example implementation, the supplemental play area 510 encloses seven vertically-stacked additional viewable portions, each viewable portion adding a symbol position to each of the plurality of reels 516 (i.e., adding an additional row). Each additional row of the supplemental play area 510 is unlocked by a certain count of instances of the feature symbol 418 appearing in the second play area 508 or a previously unlocked row of the supplemental play area 510. The count of instances of the feature symbol 418 required to unlock each additional row of the supplemental play area 510 progressively increases up the vertical stack. The count of instances of the feature symbol 418 required to unlock a first additional row (i.e., the bottom row of the supplemental play area 510) is greater than the threshold count of instances of the feature symbol 418 that satisfies the first trigger condition. In the example implementation, the bottom row of the supplemental play area 510 is unlocked by eight instances of the feature symbol 418, and this number progressively increases up the vertical stack. Unlocking the additional rows provides more opportunity for the player to increase a payout value during the feature game 500.

In the event that the feature game 500 is triggered by the first trigger condition, the total number of instances of the feature symbol 418 that appeared in the base game 400 over the tracking period are included in the second play area 508 when the spins of the feature game 500 begin. As above, in the example implementation, the threshold count of instances of the feature symbol 418 to unlock the feature game 500 is six. Thus, upon meeting or exceeding six instances of the feature symbol 418 displayed in the first play area 408 over the tracking period, the six or more instances of the feature symbol 418 are included in the second play area 508 as the spins of the feature game 500 begin. With six or more instances of the feature symbol 418 displayed in the second play area 508, a player may anticipate that unlocking at least one of the additional rows of the supplemental play area 510 will likely occur.

In the event that the feature game 500 is triggered by the second trigger condition, as is the case in this example implementation, fewer instances of the feature symbol 418 than the threshold count have appeared and are displayed in the second play area 508 as the spins of the feature game 500 begin. Thus, a player may perceive that unlocking the additional rows of the supplemental play area 510 is a daunting task. To alleviate this, additional instances of the feature symbol 418 are added to the second play area 508 such that the number of instances of the feature symbol 418 in the second play area 508 as the spins of the feature game 500 begin meets or exceeds the threshold count of instances of the feature symbol 418 required to satisfy the first trigger condition. In this way, a player does not perceive any reduced opportunity to achieve the greater awards of the feature game 500 whether the feature game 500 is triggered by the first trigger condition or the second trigger condition.

Compared to approaches in which a second chance RNG pull is not generated for each instance of the feature symbol 418 appearing during the base game 400, implementing a symbol-driven trigger approach can be more complicated and cause payout volatility. Because each instance of the feature symbol 418 is assigned a payout value, adding instances of the feature symbol 418 not only enables a player a chance to win awards during the feature game 500 but also awards prizes on the feature symbol instances themselves. In the event that a single instance of the feature symbol 418 appears during the base game 400 and the generated second chance RNG pull triggers the feature game 500, at least five additional payouts are awarded as five instances of the feature symbol 418 are added to meet the threshold count. As above, the lookup table associated with each feature symbol 418 and used for each second chance RNG pull may be appropriately weighted to control RTP and payout volatility.

Additional control over RTP and payout volatility may be facilitated by adding the additional instances of the feature symbol 418 to meet or exceed the threshold count after satisfying the second trigger condition to the second play area 508, rather than the first play area 408 during the base game 400. The payout value assigned to each instance of the feature symbol 418 (which are cash-on-reel symbols as described above) is determined by a separate RNG pull that maps a generated random number, using a pay table or other weight table, to a decision about what value to assign the instances of the feature symbol 418. The payout values may be more favorable for instances of the feature symbol 418 that appear during the base game 400 than for instances of the feature symbol 418 that appear during the feature game 500 to control RTP and payout volatility during the feature game 500. The additional instances of the feature symbol 418 are added to the second play area 508 during the feature game 500, rather than during the base game 400, such that the payout values assigned to the additional instances of the feature symbol 418 are determined by an RNG pull using the weight tables of the feature game 500 rather than the weight tables of the base game 400 to better control and balance the RTP.

To further illustrate, reference is made to the sequence shown in FIGS. 5-7. As above, in the outcome of FIG. 5, a single instance of the feature symbol 418 appears in the first play area 408 and the second chance RNG pull associated with the instance of the feature symbol 418 triggers the feature game 500. The single instance of the feature symbol 418 is held or transferred into the second play area 508 of the feature game 500. Subsequently, five additional instances of the feature symbol 418 are added to the second play area 508 such that the number of instances of the feature symbol 418 in the second play area 508 meets the threshold count of six feature symbol instances. Each payout value assigned to each of the additional five instances of the feature symbol 418 is determined by an RNG pull using weight tables of the feature game 500. These additional instances of the feature symbol 418 are shown in FIG. 7 in the bottom three rows of the second play area 508 and each is assigned a payout value less than the payout value assigned the 150 credit symbol that appeared during the base game 400 in FIG. 5. FIG. 7 also shows the outcome of a free spin during the feature game 500 in which two additional instances of a credit symbol (including the 500 credit symbol in the top row of the second play area 508) appeared. The two additional instances of a credit symbol bring the total number of instances of the feature symbol 418 in the second play area 508 to eight, which unlocks the bottom row of the supplemental play area 510. A prize is awarded for the instances of the feature symbol 418 in the second play area 508, the instances of the feature symbol 418 in the bottom row of the supplemental play area 510, and for any additional instances of the feature symbol 418 that may appear upon subsequent free spins of the feature game 500.

With reference now to FIGS. 8 and 9, a second implementation of generating second chance opportunities during the base game 600 (FIG. 8) to trigger the feature game 700 (FIG. 9) is shown. The base game 600 and the feature game 700 are displayed on the display screen 602. The display screen 602 includes a jackpot area 604, a metamorphic area 606, and a play area 608. The metamorphic area 606 includes a metamorphic 610. The metamorphic 610 is transformed during play of the base game 600 between multiple states or levels, which are associated with the first and/or second trigger conditions for the feature game 700. Transformation of the metamorphic 610 associated with the first and second trigger conditions for the feature game 700, along with additional animations displayed in the metamorphic area 606, will be described in further detail below.

The play area 608 encloses viewable portions of a set of reels 616 (also referred to herein as a plurality of reels 616). In the base game 600, the play area 608 encloses viewable portions of five reels 616a-616e. For each of the plurality of reels 616, the viewable portion of each reel includes three positions for a symbol of the reel. The symbol set for each of the plurality of reels 616 has various types of symbols, including a feature symbol 618 and other symbols (not labeled). The feature symbol 618 is a cash-on-reel symbol in this example. Each instance of a cash-on-reel symbol is assigned a payout value that is awarded (as a monetary or credit value) in response to displaying the cash-on-reel symbol. The payout value assigned to each instance of a cash-on-reel symbol appearing in the play area 608 may be awarded after the base game 600 or after the feature game 700, if triggered. Each instance of a cash-on-reel symbol displays the monetary or credit payout value assigned to the instance of the cash-on-reel symbol. Alternatively, the play area 608 can have some other configuration of reels (different dimensions) and/or have a different type of feature symbol 618. The play area 608 may also be referred to herein as a “reel matrix” or a “matrix of symbols.”

In the example base game 600, when one or more instances of the feature symbol 618 appear in the play area 608 during the base game 600, the feature game 700 (FIG. 9) may be triggered by either the first trigger condition or the second trigger condition. As above, the first trigger condition is satisfied upon a number of instances of the feature symbol 618 appearing in the play area 608 during the base game 600 that meets or exceeds a threshold count. In the example base game 600, the threshold count is six instances of the feature symbol 618. The threshold count may be any number of instances of the feature symbol 618 in other examples, and may be selected based on RTP and other considerations. Moreover, the threshold count to satisfy the first trigger condition may be met or exceeded by instances of the feature symbol 618 appearing over the course of multiple outcomes of the base game 600 displayed during a single tracking period, described in detail elsewhere herein. As description of the example implementation shown in FIGS. 8 and 9 proceeds, it will be assumed that the threshold count of instances of the feature symbol 618 to satisfy the first trigger condition has not been met or exceeded during the tracking period.

In the outcome of the base game 600 shown in FIG. 8, three instances of the feature symbol 618 appear in the play area 608. As the first trigger condition is not satisfied by the three instances of the feature symbol 618 appearing in the play area 608, a second chance RNG pull is generated to determine whether the second trigger condition is satisfied. In this example implementation, a single second chance RNG pull for the second trigger condition is generated in response to the three instances of the feature symbol 618 appearing in the play area 608 and in response to the first trigger condition not being satisfied. The second chance RNG pull is generated utilizing a lookup table that is associated with the number of instances of the feature symbol 618 appearing in the play area 608. Thus, in this example, the single second chance RNG pull is generated by mapping a generated random number, using the lookup table associated with three instances of the feature symbol 618 appearing in the play area 608, to an outcome or a decision that determines whether the second condition is satisfied to trigger the feature game 700. In other example outcomes of the base game 600, where a different number of instances of the feature symbol 618 appear, a different lookup table is used.

Each of the different lookup tables used for the second chance RNG pull, based on the number of instances of the feature symbol 618 that appear, have different weights to control the probability that the second chance RNG pull will trigger the feature game 700. Each lookup table is weighted differently, that is, each lookup table has a different probability of mapping a random number to an outcome that satisfies the second condition. In particular, each table includes a sub-range of numbers, and a match between the random number generated by the RNG and one of the sub-range of numbers satisfies the second condition. The population of the sub-range of numbers is in proportion to a probability of the respective lookup table that the random number generated by the RNG satisfies the second condition, and the probability of each lookup table is different. Suitably, the different lookup tables are weighted such that the probability that a feature game 700 is triggered increases for certain numbers of instances of the feature symbol 618 and decreases for certain other numbers of instances of the feature symbol 618. This may reflect a desired number of feature symbols with which the feature game 700 begins, described in more detail below. Moreover, the varying weights of the lookup tables facilitate controlling randomness and volatility by controlling the distribution of second chance RNG pull outcomes that satisfy the second trigger condition (i.e., controlling the overall “hit rate” of the second trigger condition).

As indicated by the sequence between FIGS. 8 and 9, the second chance RNG pull generated, utilizing a lookup table associated with the three instances of the feature symbol 618 that appeared, satisfied the second condition to trigger the feature game 700. As above, the feature game 700 shown and described may also be triggered by satisfying the first condition (i.e., displaying a threshold count of instances of the feature symbol 618 over the tracking period). That is, the first trigger condition and the second trigger condition may trigger the same feature game 700. However, in other embodiments, the first trigger condition and the second trigger condition may trigger different feature games.

The feature game 700 in this example implementation is a hold-and-spin bonus game displayed on the display screen 602. The display screen 602 includes the jackpot area 404, a bonus icon display 706, and a second play area 708. The feature game 700 includes a number of free spins, such as three, four, five, or six free spins. The outcome of each spin of the feature game 700 is displayed in the second play area 708 that replaces the play area 608 (which may also be referred to as the first play area 608) on the display screen 602. The second play area 708 encloses viewable portions of a (also referred to herein as a second plurality of reels 516). The second play area 708 initially has the same dimensions as the first play area 608 in this example implementation. Thus, the second play area 708 initially encloses viewable portions of five reels 716a-716e, and for each of the second plurality of reels 716, the viewable portion of each reel initially includes three positions for a symbol of the reel. The second set of reels 716 may be the same set of reels (i.e., includes the same reel strips) as the first set of reels 616, or may be a different set of reels. In the example implementation, the symbol set for each of the plurality of reels 716 includes the feature symbols 618 and bonus icons indicated in the bonus icon display 706. Displaying bonus icons in the second play area 708 may award additional prizes during the feature game 700. Alternatively, the second play area 708 can have some other configuration of reels (different dimensions) and/or have different types of feature symbols. During the feature game 700, instances of the feature symbol 618 in the respective symbol positions in the second play area 708 are emphasized, for example, by not showing other symbols. The second play area 708 may also be referred to herein as a “second reel matrix” or a “second matrix of symbols” and the first play area 608 referred to as the “first reel matrix” or the “first matrix of symbols.”

As shown in the sequence between FIGS. 8 and 9, each of the three instances of the feature symbol 618 that appeared in the outcome of the base game 600 in FIG. 8 is included, or graphically transferred from the first play area 608, in the second play area 708 of the feature game 700. As the spins of the feature game 700 begin, the instances of the feature symbol 618 from the base game 600 are held in position in the second play area 708. As above, the number of instances of the feature symbol 618 displayed in the second play area 708 as the spins begin corresponds to the number of instances of the feature symbol 618 that appear in the base game 600. The instances of the feature symbol 618 are shown located at the same symbol position in the second play area 708 as in the first play area 608, but may be included or transferred into a different symbol position.

As the spins of the feature game 700 continue, the instances of the feature symbol 618 from the base game 600 and additional instances of the feature symbol 618 that appear during one or more free spins are held in their respective positions. As shown in FIG. 9, the second play area 708 encloses additional viewable portions of the second set of reels 716 that are “unlocked” during the feature game 700 based on a number of instances of the feature symbol 618 appearing in the second play area 708 (the total number of instances of the feature symbol 618 from the base game 600 and any additional instances of the feature symbol 618 appearing in the second play area 708 during the feature game 700). In the example implementation, the second play area 708 encloses three vertically-stacked additional viewable portions, each viewable portion adding a symbol position to each of the plurality of reels 716 (i.e., adding an additional row). Each additional row of the second play area 708 is unlocked by a certain count of instances of the feature symbol 618 appearing in the second play area 708, or may be unlocked by displaying one of the bonus icons shown in the bonus icon display 706. The count of instances of the feature symbol 618 required to unlock each additional row progressively increases up the vertical stack. The count of instances of the feature symbol 618 required to unlock a first additional row (i.e., the row adjacent the top row of the initial second play area 708) is greater than the threshold count of instances of the feature symbol 618 that satisfies the first trigger condition. In the example implementation, the bottom row is unlocked by eight feature symbols 618, and this number progressively increases up the vertical stack. Unlocking the additional rows provides more opportunity for the player to increase a payout value during the feature game 700.

In the event that the feature game 700 is triggered by the first trigger condition, the total number of instances of the feature symbol 618 that appeared in the base game 600 over the tracking period are included in the second play area 708 when the spins of the feature game 700 begin. As above, in the example implementation, the threshold count of instances of the feature symbol 618 to unlock the feature game 700 is six. Thus, upon meeting or exceeding six instances of the feature symbol 618 displayed in the first play area 608 over the tracking period, the six or more instances of the feature symbol 618 are included in the second play area 708 as the spins of the feature game 700 begin. With six or more instances of the feature symbol 618 displayed in the second play area 708, a player may anticipate that unlocking at least one of the additional rows of the second play area 708 will likely occur.

In the event that the feature game 700 is triggered by the second trigger condition, as is the case in this example implementation, fewer than the threshold count of instances of the feature symbol 618 have appeared and are displayed in the second play area 708 as the spins of the feature game 700 begin. Thus, a player may perceive that unlocking the additional rows of the second play area 708 is a daunting task. To alleviate this, the second chance RNG pull lookup tables associated with a greater number of instances of the feature symbol 618 may be weighted with a higher probability such that the feature game 700 triggered by a second chance RNG pull more often begins with a greater number of instances of the feature symbol 618 in the second play area 708. In this way, a player does not perceive any substantially reduced opportunity to achieve the greater awards of the feature game 700 whether the feature game 700 is triggered by the first trigger condition or the second trigger condition.

Additionally or alternatively, the weight tables used to assign payout values to the instances of the feature symbol 618 may be adjusted in conjunction with the lookup tables used for the second chance RNG pulls. For example, the weight tables may assign higher payout values to instances of the feature symbol 618 and the lookup table associated with lower numbers (e.g., one or two) of instances of the feature symbol 618 may be given higher probability to trigger the feature game 700. Thus, the probability for each lookup table is set based on at least one of i) a target number of instances of the feature symbol 618 included in the second play area 708 when the feature game 700 begins, and ii) a total payout value assigned to instances of the feature symbol 618 included in the second play area 708 when the feature game 700 begins. In this way, the feature game 700 may begin more often with fewer instances of the feature symbol 618 in the second play area 708, but the payout values for instances of the feature symbol 618 are greater. Thereby, player excitement can be maintained, and RTP and payout volatility can be controlled.

Metamorphics that Visually Indicate Feature game Trigger Status.

With reference to FIGS. 4-9, metamorphics used in conjunction with the alternative implementations for generating second chance opportunities to trigger a feature game using a symbol-driven mechanic will now be described. It will be appreciated that the metamorphics used in the implementation may be interchangeably used for other implementations of the presently disclosed subject matter (e.g., in the base game 600 shown in FIG. 8). The metamorphics have a current state (also referred to herein as a first state) with any of multiple possible states. The multiple possible states can correspond to different counts of instances of a feature symbol (e.g., feature symbol 418 and/or feature symbol 618) that have appeared during the base game (e.g., base game 400 and/or base game 600) over a tracking period. Each instance of a feature symbol appearing causes the metamorphic to advance from the current state to a second state or an intermediate state that indicates that the feature game is closer to being triggered based on the display of the feature symbol. Upon triggering a feature game (e.g., feature game 500 and/or feature game 700), the current state of the metamorphic advances to a final state that indicates the feature game is triggered. During play of the feature game, the metamorphic may be hidden. After play of the feature game, the metamorphic is reset to an initial state value and the tracking period is restarted.

As described above, in the base game 400, a first metamorphic 410 and a second metamorphic 412 are displayed in the metamorphic area 406. The first metamorphic 410 is a herd of buffalo and the second metamorphic 412 is a BONUS meter.

The level of the meter metamorphic 412 visually depicts the status of the first trigger condition (e.g., a count of instances of the feature symbol 418 displayed and/or a remaining count of instances of the feature symbol 418 required to meet the threshold count). The level of the meter metamorphic 412 persists between successive plays of the base game 400 during a tracking period, and resets to its initial or minimum state (i.e., an empty meter) after a feature game 500 is triggered and played. Each instance of the feature symbol 418 appearing causes the level of the meter metamorphic 412 to advance (i.e., increase). The meter metamorphic 412 may advance between any number of intermediate levels to show that the first trigger condition is closer to being satisfied for each instance a feature symbol 418 appears. Each level represents an incremental increase of the meter metamorphic 412. For example, the meter metamorphic 412 may advance, randomly or in a predetermined manner, between 100 increments. Each instance of the feature symbol 418 appearing may advance the meter metamorphic 412 between one and ten increments, selected randomly or predetermined. As the count of instances of the feature symbol 418 continues to increase over a tracking period, the increment size of the advance of the metamorphic meter 412 may reduce in size for each additional feature symbol 418 appearing. Once the threshold count of instances of the feature symbol 418 is met or exceeded, the meter metamorphic 412 fills up to indicate that the feature game 700 is triggered. In addition, as shown in FIG. 5, the meter metamorphic 412 fills up when the second trigger condition is satisfied to indicate that the feature game 700 is triggered.

In addition to the meter metamorphic 412, buffalo herd metamorphic 410 constantly plays in the metamorphic area 406. Transformation (or animation) of meter metamorphic 412 and the buffalo herd metamorphic 410 may be synchronized and occurs for each instance that a feature symbol 418 appears. The buffalo herd metamorphic 410 may transform between any number of different states or intensity levels, such as between ten or between 15 different intensity levels. At each intensity level, movement of the buffalo herd changes. The intensity level increases for each instance that a feature symbol 418 appears. The increase in intensity level may be randomly selected. At a minimum or initial intensity level, the buffalo herd moves slowest, and the speed of the herd increases as the intensity level increases. At the final intensity level of the buffalo herd metamorphic 410, reached upon triggering the feature game 700 either by satisfying the first trigger condition or the second trigger condition, the buffalo herd stampedes to indicate that the feature game 700 is triggered. Additional animation in conjunction with the stampede state of the buffalo herd metamorphic 410 may also be displayed in the metamorphic area 406 After play of the feature game 700, the buffalo herd metamorphic resets to its initial state.

In the base game 600, the metamorphic 610 displayed in the metamorphic area 606 may also transform states to visually depict the status of the first trigger condition (e.g., a count of feature symbols 618 displayed and/or a remaining count of feature symbols 618 required to meet the threshold count). Alternatively, the metamorphic 610 may constantly change during play of the game independent of the first trigger condition status. The metamorphic 610 may be transformed to a state upon triggering the feature game 700 that indicates as much. For example, in the example shown in FIG. 8, the metamorphic 610 is a smiling face, and the eyes of the face may transform to hearts with animation behind or adjacent the face metamorphic 610 also displayed to indicate that the feature game 700 is triggered, by the first trigger condition or the second trigger condition.

### Example Computer-Implemented Process for Generating Second Chance Opportunities.

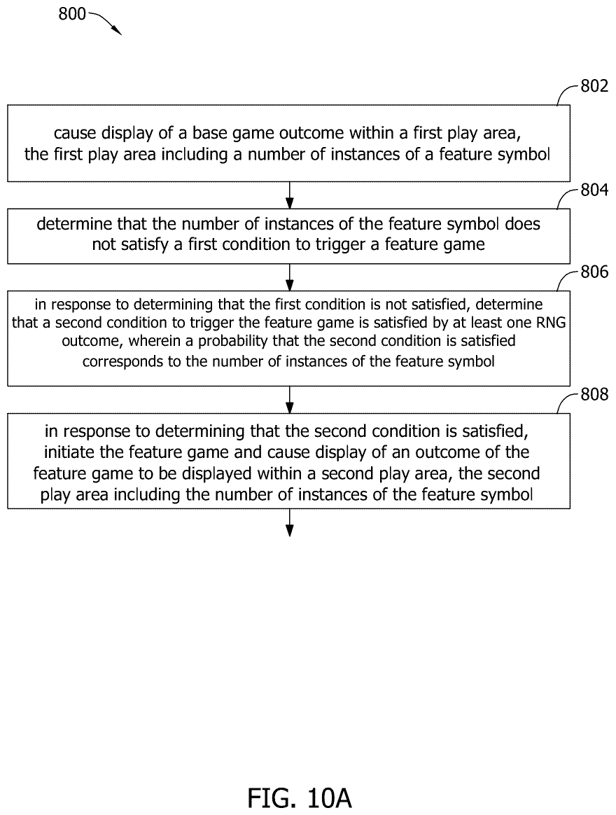

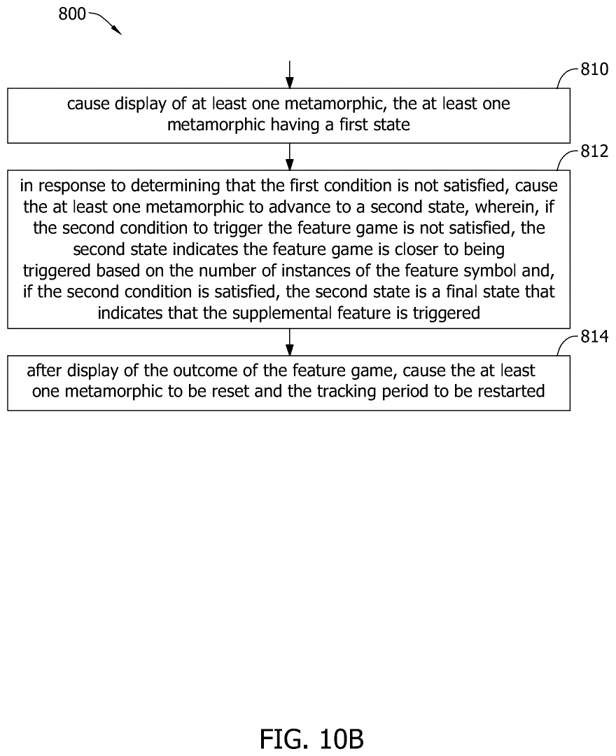

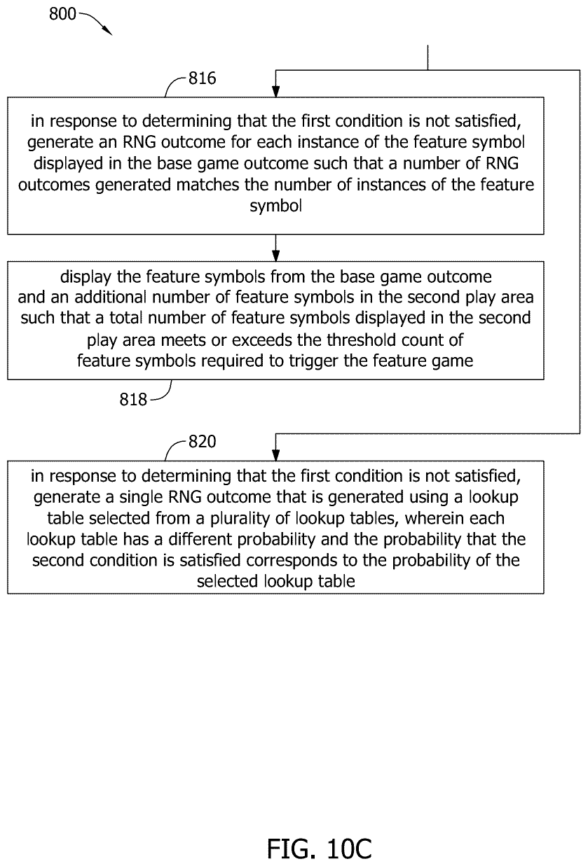

With reference to FIGS. 10A-10C, an example computer-implemented method 800 for generating second chance opportunities is shown. The example method 800 may be implemented in a server (e.g., server 102) and/or a gaming device (e.g., gaming devices 104A-104X in FIG. 1, and/or gaming device 200 and/or mobile gaming device 256 in FIG. 2). For example, in an electronic gaming device, a game controller (e.g., game controller 202) includes one or more processors 204 operatively coupled to memory 208. The memory 208 can store one or more game programs 206 that provide program instructions and/or data for carrying out various implementations (e.g., game mechanics) that, when executed by the processor 204, cause the processor 204 to perform certain operations to perform the method 800.

As shown in FIG. 10A, the method 800 includes, at a step 802, causing display of an outcome of a base game (e.g., base game 400 and/or base game 600) within a first play area (e.g., play area 408 and/or play area 608). The first play area includes a number of instances of a feature symbol (e.g., feature symbol 418 and/or feature symbol 618). The method also includes, at a step 804, determining that the number of instances of the feature symbol displayed in the first play area does not satisfy a first condition to trigger a feature game (e.g., feature game 500 and/or feature game 700). The first condition is a threshold count of instances of the feature symbol displayed in the first play area during a tracking period. The tracking period restarts each time the feature game is triggered.

At a step 806, in response to determining that the first condition is not satisfied, the method 800 includes determining that a second condition to trigger the feature game is satisfied by at least one random number generator (RNG) outcome (also referred to herein as a second chance RNG pull). The at least one RNG outcome is generated by generating a random number using an RNG and performing a lookup operation for the random number in a lookup table stored in the memory. The probability that the second condition is satisfied by the at least one RNG outcome corresponds to the number of instances of the feature symbol in the first play area. At a step 808, in response to determining that the second condition is satisfied by the at least one RNG outcome, the method 800 includes initiating the feature game and causing display of an outcome of the feature game within a second play area (e.g., second play area 508 and/or second play area 708). The second play area includes the number of instances of the feature symbol.

As shown in FIG. 10B, the method 800 may also include additional steps performed in conjunction with the steps 802-808. The method 800 may include, at a step 810, causing display of at least one metamorphic (e.g., the buffalo herd metamorphic 410, the meter metamorphic 412, or the face metamorphic 610). The at least one metamorphic has a first or current state indicating a count of instances that the feature symbol has been displayed in the first play area prior to the base game outcome during the tracking period. The method 800 may also include, at a step 812, in response to determining that the first condition not satisfied, causing the at least one metamorphic to advance to a second state. The second state of the at least one metamorphic depends on whether a second chance RNG pull satisfies the second trigger condition. If the second trigger condition is not satisfied, the second state is an intermediate state that indicates the feature game is closer to being triggered based on the display of the number of instances of the feature symbol in the base game outcome. When the second condition to trigger the feature game is satisfied, the second state is a final state that indicates that the feature game is triggered. The method 800 may also include, at a step 814, after display of the feature game, causing the at least one metamorphic to be reset and the tracking period to be restarted.

As shown in FIG. 10C, the method 800 may also include additional steps performed in conjunction with the steps 802-808 and, optionally, in conjunction with the steps 810-814. For example, in the method 800, a number of second chance RNG pulls may be generated. Specifically, at a step 816, a second chance RNG pull is generated for each instance of the feature symbol. As such, the number of second chance RNG pulls that are generated matches the number of instances of the feature symbol. After the step 816, the method 800 may also include, at a step 818, displaying the number of instances of the feature symbol and an additional number of instances of the feature symbol in the second play area such that a total number of feature symbols displayed in the second play area meets or exceeds the threshold count of instances of the first symbol required for the first condition. The appearance of the additional number of instances of the feature symbol is delayed until after initiation of the feature game. That is, the additional number of instances of the feature symbol are not shown in the first play area, only the second play area. The additional number of instances of the feature symbol may be assigned payout values from a different weight table than the number of instances of the feature symbol that appeared in the first play area in the base game outcome. In addition or in the alternative to steps 816-818, the method 800 may also include, at a step 820, in response to determining that the first condition is not satisfied, generating a single RNG outcome utilizing a lookup table associated with the number of instances of the feature symbol in the first play area. The single RNG outcome generated at the step 820 is generated by generating a random number using an RNG, selecting, based on the number of instances of the feature symbol, the lookup table from a plurality of lookup tables stored in the memory, and performing a lookup operation for the random number in the selected lookup table. Each of the plurality of lookup tables is associated with a respective number of instances of the feature symbol, and each lookup table has a different probability. As such, the probability that the second condition is satisfied by the RNG outcome corresponds to the probability of the selected lookup table.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the embodiments described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g. an EEPROM). Further, different parts of the computer software can be executed by different devices, such as, for example, in a client-server relationship. Persons skilled in the art will appreciate that computer software provides a series of instructions executable by the processor.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
a memory; and
a processor configured to execute instructions stored in the memory, which when executed, cause the processor to:
cause display of a base game outcome within a first play area, the first play area including a number of instances of a feature symbol;
determine that the number of instances of the feature symbol displayed in the first play area does not satisfy a first condition to trigger a feature game, the first condition being a threshold count of instances of the feature symbol displayed in the first play area during a tracking period that restarts each time the feature game is triggered;
in response to determining that the first condition is not satisfied, determine that a second condition to trigger the feature game is satisfied by at least one random number generator (RNG) outcome generated by generating a random number using an RNG and performing a lookup operation for the random number in a lookup table stored in the memory, wherein a probability that the second condition is satisfied by the at least one RNG outcome corresponds to the number of instances of the feature symbol in the first play area; and
in response to determining that the second condition is satisfied, initiate the feature game and cause display of an outcome of the feature game within a second play area, the second play area including the number of instances of the feature symbol.

2. The electronic gaming system of claim 1, wherein the instructions, when executed, further cause the processor to:
cause display of at least one metamorphic, the at least one metamorphic having a first state indicating a count of instances of the feature symbol displayed in the first play area prior to the base game outcome during the tracking period; and
in response to determining that the first condition is not satisfied, cause the at least one metamorphic to advance to a second state that indicates the feature game is closer to being triggered based on the number of instances of the feature symbol.

3. The electronic gaming system of claim 2, wherein the instructions, when executed, further cause the processor to, in response to determining that the second condition is satisfied, cause the at least one metamorphic to advance to a final state that indicates that the feature game is triggered.

4. The electronic gaming system of claim 3, wherein the instructions when executed, further cause the processor to, after display of the outcome of the feature game, cause the at least one metamorphic to be reset and the tracking period to be restarted.

5. The electronic gaming system of claim 1, wherein the number of instances of the feature symbol is greater than one and less than the threshold count of instances of the feature symbol required to satisfy the first condition, and wherein the at least one RNG outcome includes a number of RNG outcomes, an RNG outcome being generated for each instance of the feature symbol such that the number of RNG outcomes generated matches the number of instances of the feature symbol.

6. The electronic gaming system of claim 5, wherein each RNG outcome is generated using the same lookup table.

7. The electronic gaming system of claim 5, wherein the instructions, when executed, further cause the processor to, after initiation of the feature game, cause display of an additional number of instances of the feature symbol in the second play area such that a total number of instances of the feature symbol in the second play area meets or exceeds the threshold count of instances of the feature symbol required to satisfy the first condition.

8. The electronic gaming system of claim 7, wherein the feature symbol is a cash-on-reel symbol, each of the number of instances of the feature symbol in the first play area being assigned a payout value that is determined from a first weight table stored in the memory, and each of the additional number of instances of the feature symbol in the second play area being assigned a payout value that is determined from a second weight table stored in the memory that is different from the first weight table.

9. The electronic gaming system of claim 8, wherein the payout value assigned to each of the additional number of instances of the feature symbol from the second weight table is less than the payout value assigned to each of the number of instances of the feature symbol from the first weight table.

10. The electronic gaming system of claim 1, wherein the at least one RNG outcome is a single RNG outcome generated by:
generating a random number using an RNG,
selecting, based on the number of instances of the feature symbol, the lookup table from a plurality of lookup tables stored in the memory, each of the plurality of lookup tables being associated with a respective number of instances of the feature symbol, and
performing a lookup operation for the random number in the selected lookup table;
wherein each lookup table has a different probability such that the probability that the second condition is satisfied by the RNG outcome corresponds to the probability of the selected lookup table.

11. The electronic gaming system of claim 10, wherein the plurality of lookup tables includes a first lookup table and a second lookup table, the first lookup table being associated with a greater number of instances of the feature symbol than the second lookup table, and the first lookup table having a greater probability for the RNG outcome to satisfy the second condition than the second lookup table.

12. The electronic gaming system of claim 10, wherein the probability of each lookup table is set based on a target number of instances of the feature symbol included in the second play area during the feature game.

13. The electronic gaming system of claim 10, wherein the feature symbol is a cash-on-reel symbol, each of the number of instances of the feature symbol in the first play area being assigned a payout value that is determined from a weight table stored in the memory.

14. The electronic gaming system of claim 13, wherein the plurality of lookup tables includes a first lookup table and a second lookup table, the first lookup table being associated with a greater number of instances of the feature symbol than the second lookup table, and, when the second lookup table has a greater probability for the RNG outcome to satisfy the second condition than the first lookup table, the weight table is adjusted to increase the payout value assigned to each of the number of instances of the feature symbol in the first play area.

15. The electronic gaming system of claim 13, wherein the probability for each lookup table is set based on at least one of i) a target number of instances of the feature symbol in the second play area upon initiation of the feature game, and ii) a total payout value of the number of instances of the feature symbol in the second play area upon initiation of the feature game, calculated based on the payout value assigned to each of the number of instances of the feature symbol from the weight table.

16. A non-transitory computer-readable medium containing instructions embodied thereon, which when executed by a processor, cause the processor to:
generate a base game outcome to be displayed within a first play area, the first play area including a number of instances of a feature symbol;
determine that the number of instances of the feature symbol displayed in the first play area does not satisfy a first condition to trigger a feature game, the first condition being a threshold count of instances of the feature symbol displayed in the first play area during a tracking period that restarts each time the feature game is triggered;
in response to determining that the first condition is not satisfied, determine that a second condition to trigger the feature game is satisfied by at least one random number generator (RNG) outcome generated by generating a random number using an RNG and performing a lookup operation for the random number in a lookup table, wherein a probability that the second condition is satisfied by the at least one RNG outcome corresponds to the number of instances of the feature symbol in the first play area; and
in response to determining that the second condition is satisfied, initiate the feature game and generate an outcome of the feature game to be displayed within a second play area, the second play area including the number of instances of the feature symbol.

17. The non-transitory computer-readable medium of claim 16, wherein the number of instances of the feature symbol is greater than one and less than the threshold count of instances of the feature symbol required to satisfy the first condition, and wherein the at least one RNG outcome includes a number of RNG outcomes, an RNG outcome being generated for each instance of the feature symbol such that the number of RNG outcomes generated matches the number of instances of the feature symbol.

18. The non-transitory computer-readable medium of claim 17, wherein the instructions, when executed, further cause the processor to, after initiation of the feature game, generate an additional number of instances of the feature symbol to be displayed in the second play area such that a total number of instances of the feature symbol in the second play area meets or exceeds the threshold count of instances of the feature symbol required to satisfy the first condition.

19. The non-transitory computer-readable medium of claim 16, wherein the at least one RNG outcome is a single RNG outcome generated by:
generating a random number using an RNG,
selecting, based on the number of instances of the feature symbol, the lookup table from a plurality of lookup tables, each of the plurality of lookup tables being associated with a respective number of instances of the feature symbol, and
performing a lookup operation for the random number in the selected lookup table;
wherein each lookup table has a different probability such that the probability that the second condition is satisfied by the RNG outcome corresponds to the probability of the selected lookup table.

20. A computer-implemented method for providing a game on an electronic gaming system, the method comprising:
generating a base game outcome to be displayed within a first play area, the first play area including a number of instances of a feature symbol;
determining that the number of instances of the feature symbol displayed in the first play area does not satisfy a first condition to trigger a feature game, the first condition being a threshold count of instances of the feature symbol displayed in the first play area during a tracking period that restarts each time the feature game is triggered;
in response to determining that the first condition is not satisfied, determining that a second condition to trigger the feature game is satisfied by at least one random number generator (RNG) outcome generated by generating a random number using an RNG and performing a lookup operation for the random number in a lookup table, wherein a probability that the second condition is satisfied by the at least one RNG outcome corresponds to the number of instances of the feature symbol in the first play area; and
in response to determining that the second condition is satisfied, initiating the feature game and generating an outcome of the feature game to be displayed within a second play area, the second play area including the number of instances of the feature symbol.
